(19) United States
(12) Patent Application Publication
(10) Pub. No.: US 2012/0206736 A1
(43) Pub. Date: Aug. 16, 2012

(54) PRINTER THAT PRINTS WITH INCREASED VISIBILITY, PRINTING METHOD AND STORAGE MEDIUM

(75) Inventor: Hirotaka KURONUMA, Tokyo (JP)

(73) Assignee: CASIO COMPUTER CO., LTD., Tokyo (JP)

(21) Appl. No.: 13/368,552

(22) Filed: Feb. 8, 2012

(30) Foreign Application Priority Data
Feb. 16, 2011 (JP) 2011-031020

(51) Int. Cl. G06K 15/02

(52) U.S. Cl. 358/1.2

(57) ABSTRACT

A printable width setter sets a printable width that corresponds to a printable width of a printing medium. A display displays a character string. A specifier specifies at least one first character selected from the character string displayed on the display. A requester requests an emphasis process to the specified at least one first character. An emphasis processor performs a size up process of increasing a size of the specified at least one first character until the size of the specified at least one first character reaches the specified size allowed based on the printable width set by the printable width setter. The emphasis processor performs a size down process of decreasing a size of the at least one second character that has not been specified by the specifier, if the size of the specified at least one first character exceeds the specified size.

### CROSS-REFERENCE TO RELATED APPLICATION

This application claims the benefit of Japanese Patent Application No. 2011-031020, filed Feb. 16, 2011, the entire disclosure of which is incorporated by reference herein.

### FIELD

This application relates generally to a printer that prints with increased visibility, to a printing method for the printer to print with increased visibility, and to a storage medium that stores a printing control program for achieving the printing method for causing the printer to perform a printing process with increased visibility.

### BACKGROUND

There is a printer as a device that can create a unique label by setting a tape cassette, which stores a tape member, into the device, and arbitrarily printing a character or the like, which is inputted from an inputter such as a keyboard or outputted from another device, onto printing tape of that tape member.

Among labels that are created by such a printer, there is a label having characters that are emphasized by a bolding process, border process, character formatting, and the like. Unexamined Japanese Patent Application KOKAI publication No. H07-052460 (hereafter referred to as “Patent Literature”) described below discloses a printer that creates dot-pattern data for emphasized characters while maintaining the quality of the characters or symbols.

However, the printer disclosed in this Patent Literature creates dot-pattern data for emphasized characters while maintaining the quality of the characters or symbols, however, the method used for emphasizing the characters did not change a size of the characters.

### SUMMARY

The present invention is made in consideration of the problem in the conventional technology described above, and has an object to provide: a printer that creates labels with increased visibility using an emphasis process; a printing method to be used by the printer to create labels with increased visibility using the emphasis process; and a storage medium that stores a printing control program for making it possible for the printer to use the printing method for creating labels with increased visibility using the emphasis process.

In order to accomplish the object above, the printer of the present invention is a printer that prints on a printing medium, and includes:

a printable width setter that sets a printable width that corresponds to a width of the printing medium;

a display that displays a character string;
a specifier that specifies at least one first character selected from the character string displayed on the display, the character string includes the specified at least one first character and at least one second character;

a requester that requests an emphasis process to the specified at least one first character; and
an emphasis processor that performs a size up process of increasing a size of the specified at least one first character according to the request of the emphasis process requested by the requester until the size of the specified at least one first character reaches the specified size allowed based on the printable width set by the printable width setter,
wherein the emphasis processor maintains the size of the specified at least one first character and performs a size down process of decreasing a size of the at least one second character that has not been specified by the specifier, if the size of the specified at least one first character exceeds the specified size.

In order to accomplish the object above, a printing method of the present invention is a printing method for printing on a printing medium, and includes the steps of:

setting a printable width that corresponds to a width of the printing medium;

inputting character string information comprising a plurality of characters to be printed on the printing medium;

displaying an inputted character string;

specifying at least one first character selected from the character string displayed on the display, the character string includes the specified at least one first character and at least one second character;

requesting an emphasis process to the specified at least one first character;

performing a size up process of increasing a size of the specified at least one first character according to the request of the emphasis process until the size of the specified at least one first character reaches the specified size allowed based on the printable width set by the printable width setting step; and

maintaining the size of the specified at least one first character and performing a size down process of decreasing a size of the at least one second character that has not been specified by the specifying step, if the size of the specified at least one first character exceeds the specified size.

In order to accomplish the object above, a storage medium of the present invention is a storage medium that stores a control program that causes a computer to perform a process to perform printing on a printing medium, and, the control program causes the computer to perform processes of:

setting a printable width that corresponds to a width of the printing medium;

inputting character string information comprising a plurality of characters to be printed on the printing medium;

displaying an inputted character string;

specifying at least one first character selected from the character string displayed on the display, the character string includes the specified at least one first character and at least one second character;

requesting an emphasis process to the specified at least one first character;

performing a size up process of increasing a size of the specified at least one first character according to the request of the emphasis process until the size of the specified at least one first character reaches the specified size allowed based on the printable width set by the printable width setting process; and

maintaining the size of the specified at least one first character and performing a size down process of decreasing a size of the at least one second character that has not been specified by the specifying process, if the size of the specified at least one first character exceeds the specified size.

The present invention can provide a printer that creates labels with increased visibility using an emphasis process; a printing method to be used by the printer to create labels with increased visibility using the emphasis process; and a storage medium that stores a printing control program for making it possible for the printer to use the printing method for creating labels with increased visibility using the emphasis process.

### BRIEF DESCRIPTION OF THE DRAWINGS

A more complete understanding of this application can be obtained when the following detailed description is considered in conjunction with the following drawings, in which:

FIG. 1 is a plan view of a printer of an embodiment of the present invention;

FIG. 2A is an enlarged internal view of the printer of the embodiment of the present invention, and FIG. 2B is a perspective view of a tape cassette;

FIG. 3 is a block diagram of functions of the printer of the embodiment of the present invention;

FIG. 4A and FIG. 4B are tables for illustrating printed character size data that is stored in the ROM of the printer of the embodiment of the present invention;

FIG. 5 is a flowchart illustrating the flow for setting the emphasis process for a character string by the printer of the embodiment of the present invention;

FIG. 6A and FIG. 6B are drawings illustrating setting of the emphasis process by the printer of the embodiment of the present invention;

FIG. 7A and FIG. 7B are drawings illustrating setting of the emphasis process by the printer of the embodiment of the present invention;

FIG. 8A to FIG. 8F are drawings illustrating a character string that has undergone the emphasis process by the printer of the embodiment of the present invention; and

FIG. 9A to FIG. 9C are drawings illustrating a character string that has undergone the emphasis process by a printer of an embodiment of the present invention.

### DETAILED DESCRIPTION

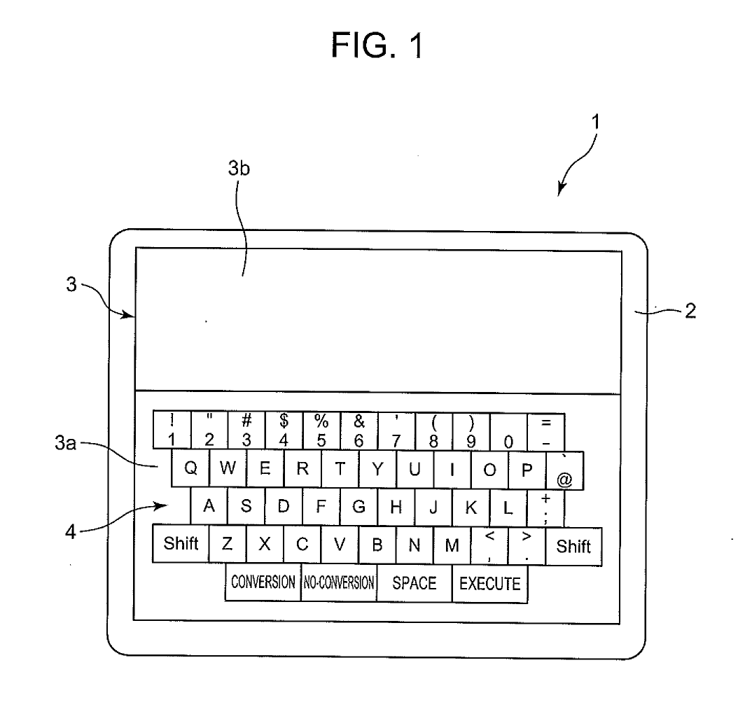

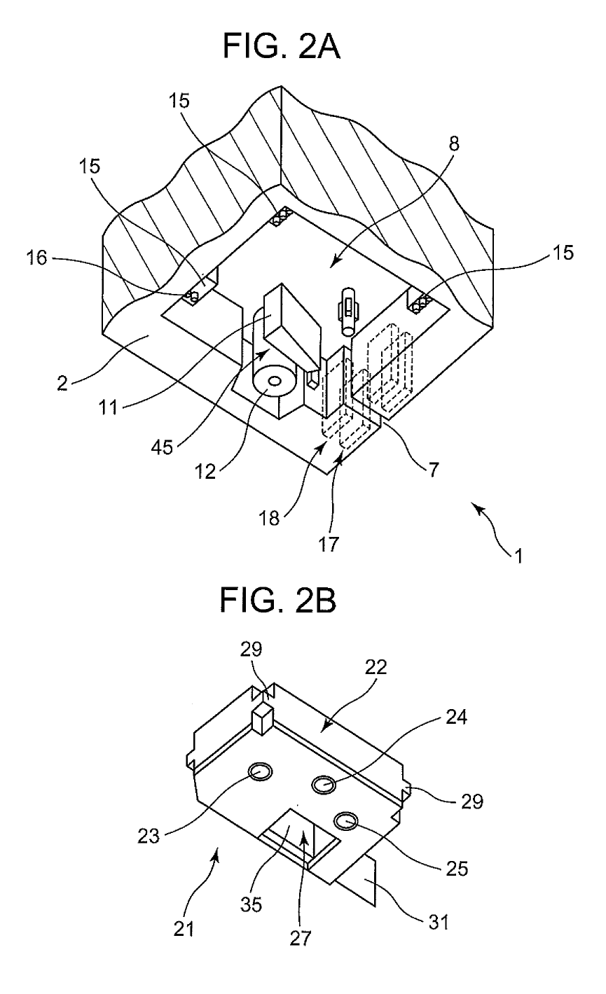

In the following, an embodiment of the present invention will be explained in detail on the basis of the drawings. FIG. 1 is a plan view of a printer 1 of the embodiment of the present invention, FIG. 2A is a perspective view illustrating an appearance of a tape cassette 21 that is used in the printer 1, and FIG. 2B is a perspective view illustrating part of the internal construction of the printer 1. The printer 1 is a device that prints characters and the like onto a tape member 31 that is formed by layering printing tape, which has a printing surface on the top surface and an adhesive surface on the underneath surface, and peeling tape, which is adhered to the adhesive surface.

As illustrated in FIG. 1, the printer 1 includes a touch-panel display 3 that is formed from a liquid-crystal display on the top surface of a frame 2 and displays a virtual keyboard using a software keyboard function. On this touch-panel display 3, a touch-panel inputter 4, which includes transparent pressure switches, is provided on the top surface of a display screen of the liquid-crystal display as a character input device.

A keyboard area 3a, which displays the virtual keyboard including character/symbol keys such as alphabet keys, number keys, and symbol keys (hereafter, these are all referred to as character keys), and control keys such as a Kanji conversion key, no-conversion key, and execute key, and a character editing area 3b, which displays characters that are inputted from the keyboard area 3a, are provided on the display screen of the touch-panel display 3. The keyboard area 3a displays the keys of the touch-panel inputter 4 as images; by pressing on the position of one of the keys that are displayed on the display screen as the touch-panel inputter 4, data corresponding to a coordinate position of that key is inputted; and this touch-panel display 3 and touch-panel inputter 4 form a software keyboard.

In order to load the tape cassette 21, a cassette loading area 8 for loading the tape cassette 21 that stores the tape member 31 and ink ribbon 35 is formed as illustrated in FIG. 2A and FIG. 2B on the inside of the open/close cover that is prepared on the back surface of the device. A tape printing mechanism 45, and cassette receiving areas 15 for supporting and keeping the tape cassette 21 in a specified position are formed inside the cassette loading area 8.

This tape printing mechanism 45 includes: printing elements that are arranged in the vertical direction, a thermal head 11 that functions as the printing head, a platen roller 12 that conveys the tape member 31 and ink ribbon 35 that are held between that platen roller 12 and the thermal head 11, and a ribbon winding shaft 13 that winds up the ink ribbon 35, which was used for printing, into the tape cassette 21.

Moreover, a tape output 7 that extends to the outside of the frame 2 is formed in part of the cassette loading area 8, and in this tape output 7 there is a full-cut mechanism 17 as a full-cutter, which cuts the printing tape and the pealing tape of the tape member 31 in the width direction (height direction), and a half-cut mechanism 18 as a half-cutter, which cuts only the printing tape of the tape member 31.

Furthermore, the tape cassette 21 includes a cassette case 22, and this cassette case 22 houses a tape core 23 around which the tape member 31 is wound, a ribbon supply core 24 around which unused ink ribbon 35 is wound, and a ribbon winding core 25 that winds up the used ink ribbon 35. Moreover, a head placement area 27, where the thermal head 11 is placed when the tape cassette 21 is loaded inside the cassette loading area 8, is formed in the cassette case 22 of the tape cassette 21.

Engagement areas 29 that engage with the cassette receiving areas 15 of the cassette loading area 8 and are supported by the cassette receiving areas 15 are formed in the corners of the cassette case 22. Specified uneven sections (not illustrated in the figure) that correspond to the type of tape cassette 21 are formed in the engagement areas 29 of the cassette case 22, and tape width (tape height) detection switches 16, which distinguish the uneven sections that are formed in the engagement areas 29 of the cassette case 22 when the tape cassette 21 is loaded, are formed in the cassette receiving areas 15 of the cassette loading area 8.

When a cassette cases 22 is loaded into the cassette loading area 8, the engagement areas 29 of the cassette case 22 engage with some or all of the tape width detection switches 16 that are formed in the cassette receiving areas 15 in the cassette loading area 8, and when the engaged tape width detection switches 16 are pressed down, the printer 1 is able to distinguish the type, such as the tape width (tape height), of the printing tape according to the combination of tape width detections switches 16 that are ON.

In other words, the type of tape cassette 21 differs depending on the width or the like of the tape member 31 housed inside, so by determining the type of tape cassette 21, the printer 1 can distinguish the width or the like of the printing tape that will be printed on, and a controller 40 can create printing data that corresponds to that tape width (height).

When a printing instruction is given to the printer 1, the tape member 31 and the ink ribbon 35 are let out from the tape cassette 21, and that tape member 31 and ink ribbon 35 are held and conveyed between the platen roller 12 and the thermal head 11 in an overlapped state.

The thermal head 11 is heated and driven according to printing data, and prints on the printing tape by thermally transferring ink from the ink ribbon 35 to the printing tape of the tape member 31, and after printing is finished, the full-cut mechanism 17 or half-cut mechanism 18 operates according to a setting and cuts the tape member 31 in the width direction to create one tape-shaped label.

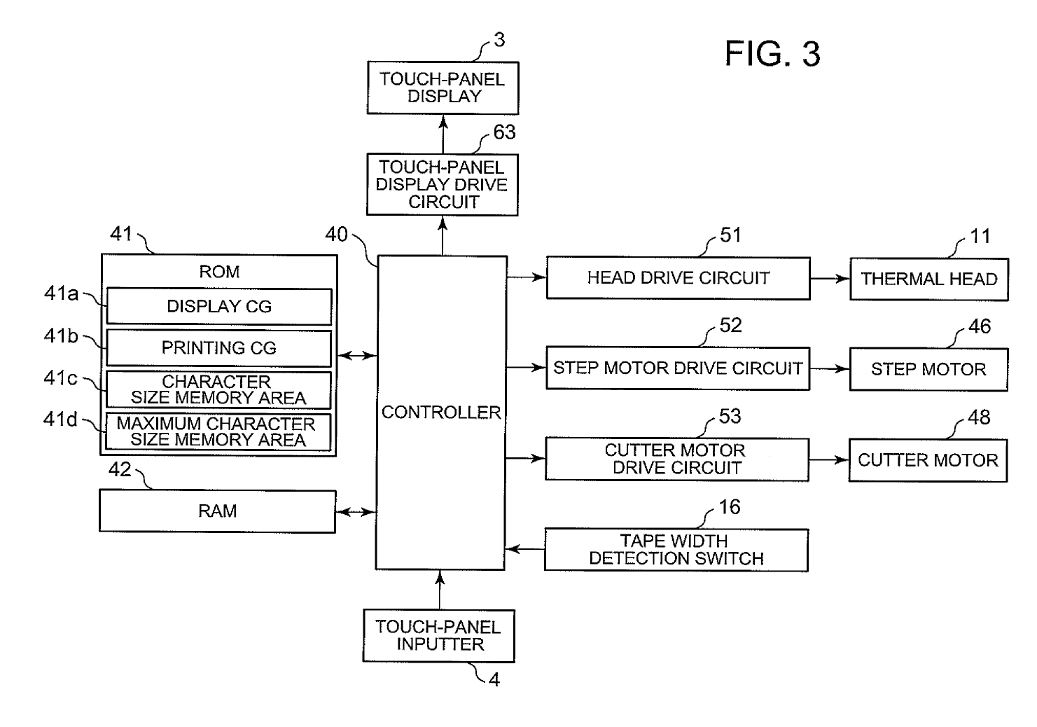

Next, a circuit configuration of the printer 1 will be described. As illustrated in FIG. 3, this printer 1 includes the controller 40. A ROM 41 and RAM 42 are connected to the controller 40 as memories. The touch-panel inputter 4 is connected to the controller 40 as a method for inputting character data, font size and the like that were received from key operation by a user. Moreover, a touch-panel display driving circuit 63 that drives the touch-panel display 3 as a method for displaying various types of information such as inputted information is connected to the controller 40.

Furthermore, a head drive circuit 51 that drives the thermal head 11, a step motor drive circuit 52 that drives a step motor 46, and a cutter motor drive circuit 53 that drives a cutter motor 48 are connected to the controller 40.

The tape width detection switches 16 as a method for distinguishing the type of cartridge are connected to the controller 40.

The controller 40 is a CPU that controls key input signals form the touch-panel inputter 4, or activates system programs that are stored in advance in the ROM 41, control programs that are stored on a memory card, control programs that are read from external devices, and the like to control the operation of all of the circuit components using the RAM 42 as a work memory.

Programs for displaying and printing set character string data or the like, printing fonts, diagonal lines and mesh used for shading, dot patterns, and the like are stored in the ROM 41, and the ROM 41 also functions as a memory medium that stores programs that can be read by the controller 40.

The ROM 41 has a display CG (character generator) 41a that stores pattern data for display fonts. Moreover, the ROM 41 has a printing CG (character generator) 41b that stores pattern data for printing fonts.

In the RAM 42 there is a printing data memory area that stores printing pattern data in which inputted printing data is expanded, and a display data memory area that stores pattern data that are displayed on the touch-panel display 3, and there are also registers and counters that temporarily store data necessary for the printing process.

The head drive circuit 51 controls the thermal head 11, which is a method of printing, according to printing information and formatting information, and causes the tape member 31 to print. The step motor drive circuit 52 is a circuit for driving a method of conveyance, and controls the step motor 46 such as a stepping motor that rotates the platen roller 12 and ribbon winding shaft 13, and conveys the tape member 31 in the lengthwise direction at a specified speed 31. The cutter motor drive circuit 53 is a drive circuit that controls a method of cutting, such as a full-cutter or half-cutter, and controls a stepping motor as the cutter motor 48 that is used by the full-cut mechanism 17, a DC motor as the cutter motor 48 that is used by the half-cut mechanism 18, or the like.

By the controller 40 controlling the head drive circuit 51, the step motor drive circuit 52, the cutter motor drive circuit 53, and the like, the printer 1 can print a character string on the tape member 31 and create a label by cutting that printed portion.

The printer 1 of this embodiment has a function that creates a label having increased visibility in an emphasized label creation mode by specifying a character string to be emphasized from among inputted character strings, and specifying the difference in character size between the emphasized character string and non-emphasized character string.

The controller 40, together with the tape width detection switches 16, which are used as a way to determine the tape width, distinguishes the type of tape width of the printing tape.

Furthermore, the controller 40 functions as a printable area setter that sets a printable area within the tape width of the loaded printing tape.

Moreover, the controller 40 also functions as an input character size setter that sets a default input character size according to the set printable area.

The controller 40 also controls the touch-panel display 3, and functions as a range specifier that specifies a character string to be emphasized from among inputted character strings that were inputted by the inputter.

Furthermore, the controller 40 also controls the touch-panel display 3, and functions as an emphasis starter that causes a menu, such as an emphasis button or the like that are used to specify the start of the emphasis process, to be displayed.

The controller 40 also functions as a size determiner that, when the emphasis button is pressed, determines whether or not the size of the printing characters of the character string that was specified by the range specifier from among the inputted character strings is equal to the maximum printing character size that corresponds to the tape width that is stored in a maximum character size memory area 41d in the ROM 41 described later.

Furthermore, when the emphasis button is pressed, the controller 40, as a character size changer, executes a character size change process that increases the printing character size one step for the character string that was specified by the range specifier when the size determiner determined that the character string to be emphasized does not have the maximum printing character size.

Moreover, the controller 40, as the character size changer, executes the character size change process that reduces the printing character size one step for printing characters other than the character string specified by the range specifier when the size determiner determined that the character string to be emphasized has the maximum printing character size.

The controller 40, as the emphasis starter, can repeatedly display a menu such as the emphasis button 70 on the touch-panel display 3 so that the specified character string can be further emphasized, and can further repeat the emphasis process until the difference between emphasized characters and non-emphasized characters becomes clear.

The controller 40, as the character size changer, may additionally execute an emphasis process of performing a bolding process such as making the character string specified by the range specifier bolder.

Furthermore, the controller 40, as the character size changer, may additionally execute an emphasis process of performing character formatting such as background processing or shading of the character string that was specified by the range specifier.

In the present invention, the ROM 41 has a character size memory area 41c as a character size memory that stores information on a pt (point) value that indicates a character size that can be set from the minimum printing character size to the maximum printing character size that can be printed by the printer, and a mm value that indicates a character height.

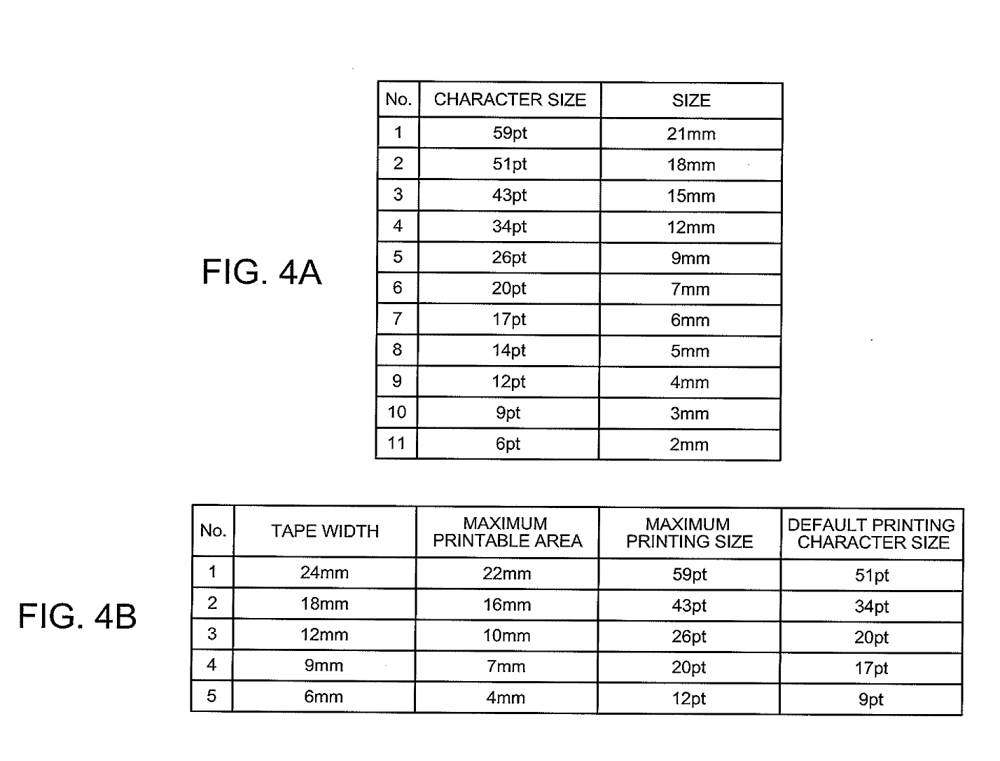

As illustrated in FIG. 4A, in the information stored in the character size memory area 41c, the minimum printing character size is 6 pt, the character height of the minimum printing character size is 2 mm, the maximum printing character size is 59 pt, and the character height of the maximum character size is 21 mm, for example.

Furthermore, the ROM 41 has a maximum character size memory area 41d as a maximum character size memory that stores the maximum printable area (mm) and the maximum printing character size (pt) that can be printed according to the tape width (mm) that can be used by the printer, and stores the default printing character size (pt).

As illustrated in FIG. 4B, in the information stored in the maximum character size memory area 41d, when the tape width is 24 mm, the maximum printable area is 22 mm, the maximum printing character size (pt) is 59 pt and the default printing character size (pt) is 51 pt; and when the tape width is 6 mm, the maximum printable area is 4 mm, the maximum printing character size (pt) is 12 pt and the default printing character size (pt) is 9 pt, for example.

In the information stored in the maximum character size memory area 41d, the default printing character size (pt), as illustrated in FIG. 4B, for example, is set to a printing character size (pt) of 51 pt when the maximum printing character size (pt) is 59 pt, and is set one step lower than the maximum printing character size (pt); however, the information is not limited to this, and the default printing character size may be set two steps or three steps smaller than the maximum printing character size (pt).

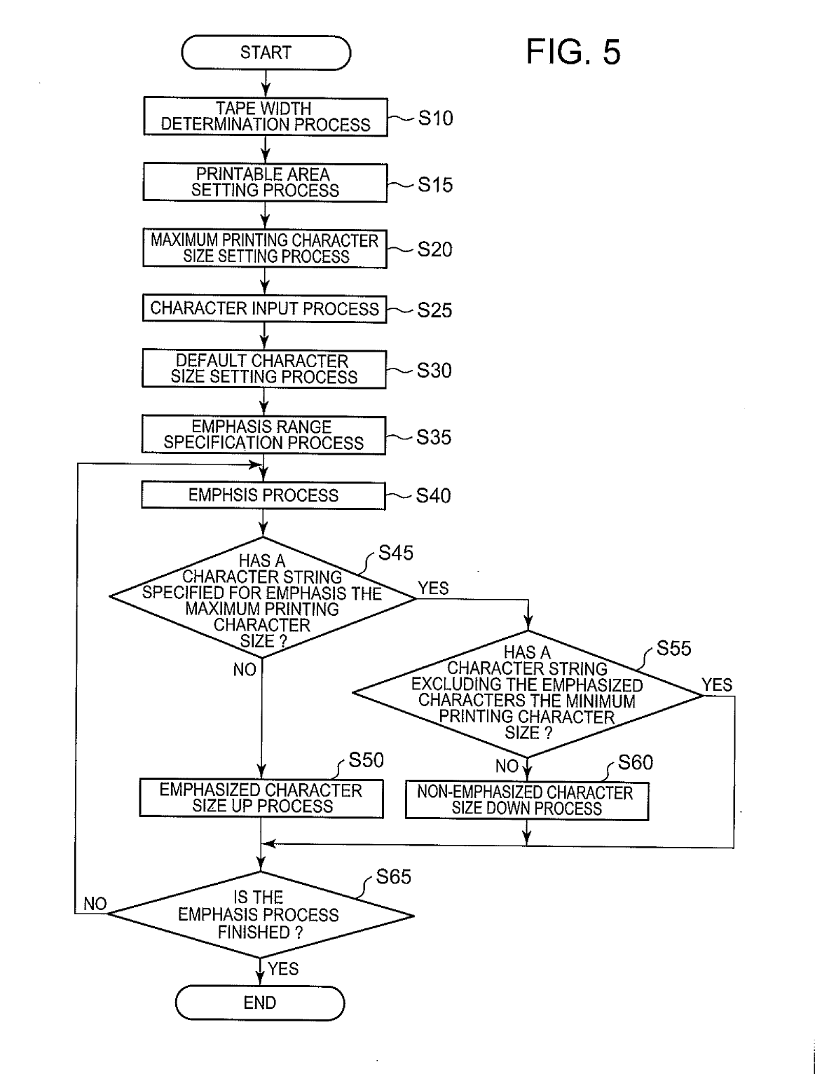

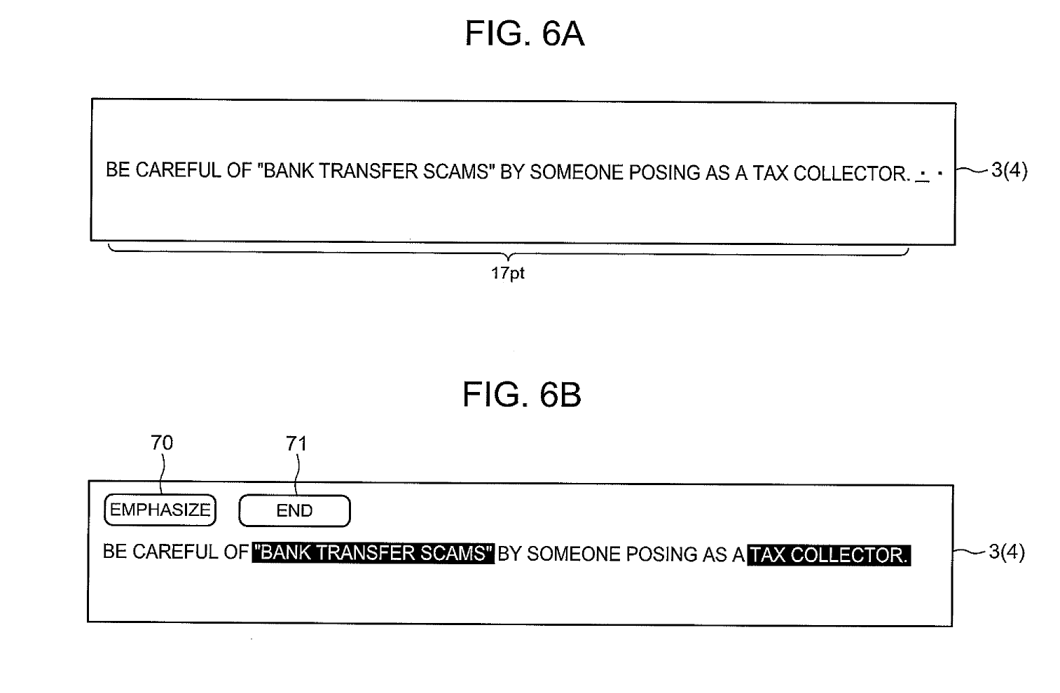

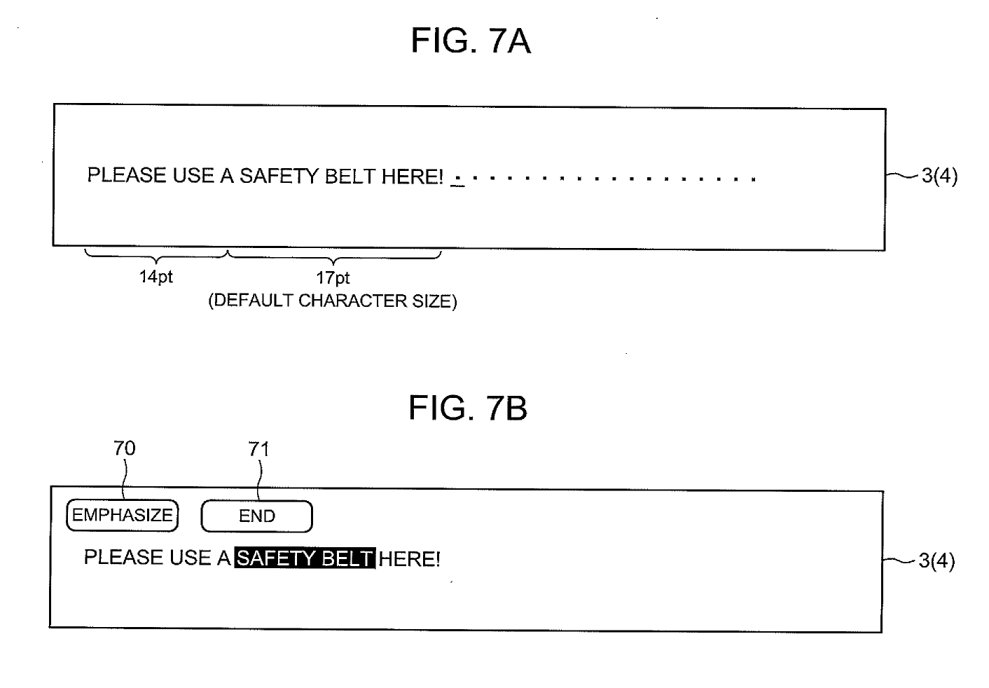

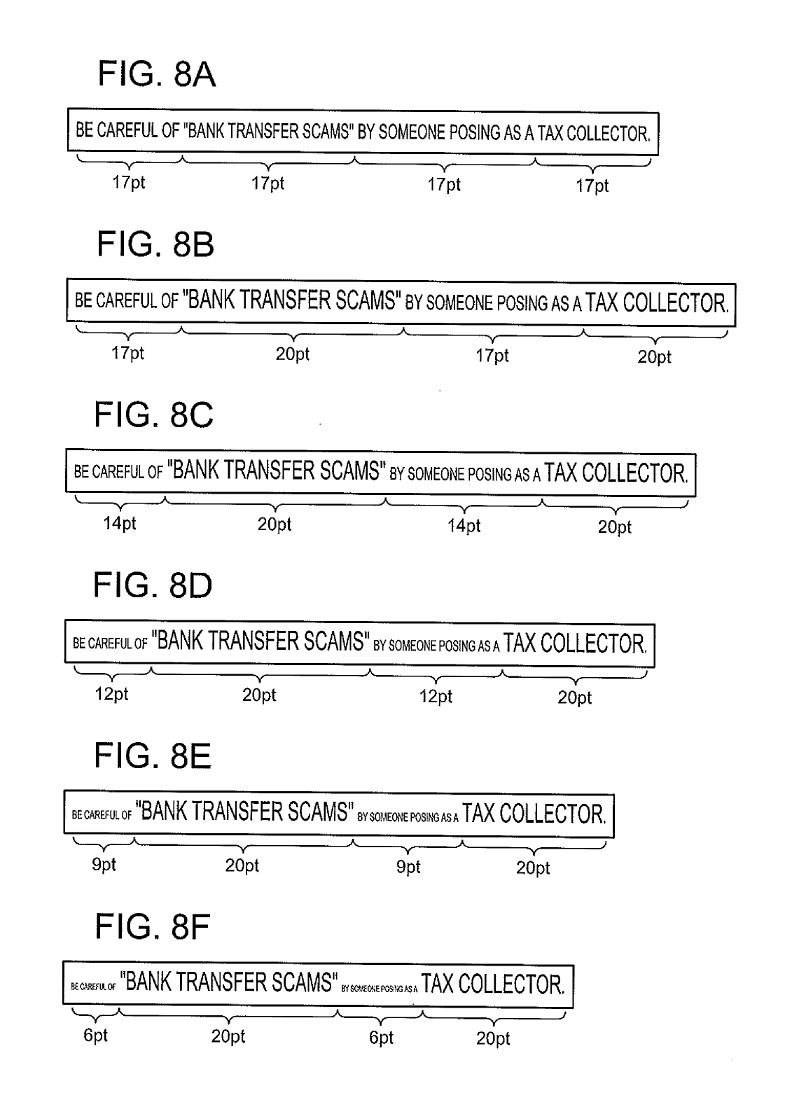

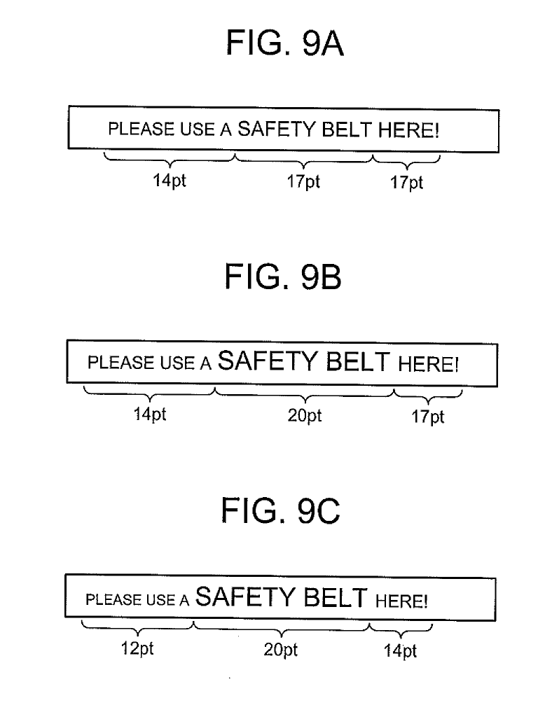

Here, the processing flow by the printer 1 when creating a label in this embodiment of the present invention is explained using the drawings. FIG. 5 is a flowchart of the processing flow by the printer 1 when creating a label for which the emphasis process is performed. FIG. 6A, FIG. 6B, FIG. 7A and FIG. 7B are drawings explaining the screen display when specifying the range of the emphasized character string from the inputted character string. FIG. 8A to FIG. 8F and FIG. 9A to FIG. 9C are drawings explaining a character string for which the emphasis process was performed.

First, after the user sets the printer 1 to the emphasized label creation mode, the controller 40 first executes the tape width determination process (step S10) that, by using the tape width detection switches 16, determines the tape width (mm) of the loaded printing tape.

Then the controller 40, based on the determined tape width (mm), executes a printable area setting process (step S15) that sets the maximum printable area (mm) for each tape width stored in the maximum printing size memory area 41d of the ROM 41. The printer 1 can also display a settable menu on the touch-panel display 3 and prompt the user to set the maximum printable area (mm).

After the maximum printable area (mm) has been set, next, the controller 40 executes a maximum printing character size setting process (step S20) that sets the maximum printing character size (pt) that can be printed for each tape width that is stored in the maximum character size memory area 41d of the ROM 41. The printer 1 can also display a settable menu on the touch-panel display 3 and prompt the user to set the maximum printing character size (pt).

Next, the controller 40 executes a character input process (step S25) that causes a message to be displayed on the touch-panel display 3, such as “Input characters.” in order to prompt the user to input characters for the emphasized label, and displays the inputted character string on the touch-panel display 3.

FIG. 6A illustrates an example of the emphasized label character string “Be careful of “Bank Transfer Scams” by someone posing as a tax collector.” that was inputted by the user and displayed on the touch-panel display 3. Moreover, FIG. 7A illustrates an example of the emphasized label character string “Please use a safety belt here.” that was inputted by the user and displayed on the touch-panel display 3.

After characters have been inputted, the controller 40 executes a default character size setting process (step S30) that sets the size of the inputted characters as the default printing character size (pt) that is set for each tape width that is stored in the maximum character size memory area 41d of the ROM 41. For example, when the tape width (mm) of the loaded printing tape is 9 mm, the controller 40, as illustrated in FIG. 6A, sets 17 pt as the default printing character size (pt).

The printing character size (pt) can be arbitrarily set to a size other than the default printing character size; for example, in the case of the emphasized label character string “Please use a safety belt here.” illustrated in FIG. 7A, the portion “Use” can be set to 14 pt from the default printing character size (pt) that is 17 pt.

Next, in order to prompt the user to specify an emphasis range, the controller 40 can cause a message such as “Specify the location in the character string to be emphasized.” to be displayed on the touch-panel display 3.

After the emphasis range has been specified by the user using a touch pen, finger, or the like on the touch-panel inputter 4, the controller 40 executes an emphasis range specifying process (step S35) that causes the character strings “Bank Transfer Scams” and “tax collector” in FIG. 6B, and “safety belt” in FIG. 7B, which were specified as the locations for the emphasis process, to be highlighted with a black background, flashing display, or the like to be displayed on the touch-panel display 3 such that they can be distinguished.

Together with the display for distinguishing the emphasized range, the controller 40 causes the emphasis button 70 for specifying the start of the emphasis process to be displayed in the upper left part of the touch-panel display 3 as illustrated in FIG. 6B and FIG. 7B, and causes an end button 71 for specifying the end of the emphasis process to be displayed on the right, next to the emphasis button 70.

After the user has pressed the emphasis button 70, the controller 40, as the character size changer, starts the emphasis process (step S40).

First, the controller 40, as the size determiner, executes an emphasis size determining process (step S45) that determines whether or not the printing character size (pt) of the character string that was specified by the range specifier is the maximum printing character side (pt) that corresponds to the tape width (mm) that is stored in the maximum character size memory area 41d of the ROM 41.

When the printing character size (pt) of the character string specified by the range specifier is not the maximum printing character size (pt), processing advances to an emphasized character size up process (step S50), and when the printing character size (pt) of the character string in the location to execute the emphasis process is the maximum printing character size (pt), processing advances to a non-emphasized character size down process (step S55).

As the emphasized character size up process (step S50), the controller 40 increases the printing character size (pt) of the character string specified by the range specifier one step in the settable printing character sizes (pt) that are stored in the character size memory area 41c of the ROM 41.

More specifically, as illustrated in FIG. 8A, of the entire characters string “Be careful of “Bank Transfer Scams” by someone posing as a tax collector.” for which the emphasis process has not yet been performed, the printing character size (pt) of the character strings “Bank Transfer Scams” and “tax collector” that are specified by the range specifier in the emphasized character size up process (step S50) is increased one step to a size of 20 pt compared to the default size of 17 pt such that the entire character string is as illustrated in FIG. 8B.

Moreover, as illustrated in FIG. 9A, of the entire characters string “Please use a safety belt here.” for which the emphasis process has not yet been performed, the printing character size (pt) of the character string “safety belt” that is specified by the range specifier in the emphasized character size up process (step S50) is increased one step to a size of 20 pt compared to the default size of 17 pt such that the entire character string is as illustrated in FIG. 9B.

The controller 40, as the character size changer, may increase the size of character strings specified by the range specifier one step, as well as can perform the emphasis process such as the bolding process for bolding characters, and/or character formatting for giving a multi-layer appearance such as background processing or shadowing. After the emphasized character size up process (step S50) is finished, processing advances to the emphasis process end determination (step S65).

When the printing character size (pt) of the character stings specified by the range specifier is the maximum printing character size (pt) that corresponds to the tape width (mm) that is stored in the maximum character size memory area 41d of the ROM 41, the controller 40 executes the non-emphasized character size down determination process (step S55) that determines whether or not the printing character size (pt) of character strings other than the character strings specified by the range specifier is the minimum printing character size (pt) of the settable printing character sizes (pt) that are stored in the character size memory area 41c.

In the non-emphasized character size down determination process (step S55), when the printing character size (pt) of the character strings other than the character strings that were specified by the range specifier is not the minimum printing character size (pt), processing advances to the non-emphasized character size down process (step S60), and when the printing character size (pt) of the character strings other than the character strings that were specified by the range specifier is the minimum printing character size (pt), it is determined that changing the printing character size (pt) of the character strings other than the character strings that were specified by the range specifier is not possible, and processing advances to the emphasis process end determination (step S65) without changing the size.

As the non-emphasized character size down process (step S60), the controller 40 reduces the printing character size (pt) of the character strings other than the character strings that were specified by the range specifier one step in the settable printing character sizes (pt) that are stored in the character size memory 41c.

More specifically, as illustrated in FIG. 8B, in the entire character string “Be careful of “Bank Transfer Scams” by someone posing as a tax collector.” that has undergone the emphasis process, when the printing character size (pt) of the character strings “Bank Transfer Scams” and “tax collector” that have already been specified by the range specifier is the maximum printing character size of 20 pt, the non-emphasized character size down process (step S60) reduces the printing character size (pt) of character strings other than the character strings specified by the range specifier one step in the settable printing character sizes (pt) that are stored in the character size memory area 41c. In other words, the character strings other than the characters strings specified by the range specifier that have the default size of 17 pt are reduced one step to 14 pt character strings, so that the entire character string that has undergone the emphasis process is as illustrated in FIG. 8C.

Moreover, as illustrated in FIG. 9B, when the printing character size (pt) of character strings that have already been specified by the range specifier are the maximum printing character size (pt) of 20 pt, the non-emphasized character size down process (step S60) reduces the printing character size (pt) of character strings other than the character strings that were specified by the range specifier one step in the settable printing character sizes (pt) that are stored in the character size printing area 41c.

In other words, the 17 pt character strings other than the character strings that were specified by the range specifier are changed to 14 pt character strings. The 14 pt character strings are reduced one step to 12 pt character strings, so that the entire character string that has undergone the emphasis process is as illustrated in FIG. 9C. After the non-emphasized character size down process (step S60) is finished, processing advances to the emphasis process end determination (step S65).

As the emphasis process end determination (step S65), the controller 40 causes the entire character string, in which size changes have been reflected, to be displayed on the touch-panel display 3, and as illustrated in FIG. 6B and FIG. 7B, causes the emphasis button 70, which is used to give an instruction to further perform the emphasis process, to be displayed in the upper left section of the screen of the touch-panel display 3, and causes the end button 71, which is used to give an instruction to end the emphasis process, to be displayed on the right of the emphasis button 70.

After the user has pressed the end button 71, the emphasis process ends, printing begins and the label is completed. However, when the emphasis button 70 for changing the printing character size (pt) is pressed, processing returns to the emphasis process (step S40), and processing for changing the size is similarly repeated for character strings that were specified by the range specifier, or for character strings other than the character strings that were specified by the range specifier.

More specifically, as illustrated in FIG. 8C, the printing character size (pt) of the character strings that have already been specified by the range specifier is set to the maximum printing character size (pt) of 20 pt, and there are character strings that have undergone the emphasis process, wherein in the non-emphasized character size down process (step S60) the character size (pt) of character strings other than the character strings specified by the range specifier is set to 14 pt. By further performing the emphasis process, the printing character size (pt) of the character strings other than the character strings specified by the range specifier is further reduced each time to 14 pt, 12 pt, 9 pt and 6 pt as illustrated in FIG. 8D, FIG. 8E and FIG. 8F, so a label can be completed for which the size has been changed to the minimum printing character size of 6 pt.

As a variation, in the bolding process, a limit value for the thickness of characters for each character size is set and stored in memory; by performing the emphasis process by only the bolding process that changes the thickness of the character, and repeating that emphasis process, the thickness of characters specified as the emphasis range is made thicker; and when the limit value for the thickness that is set for each character size is reached, the thickness of the characters that are specified as the emphasis range is no longer changed, but rather the thickness of the non-emphasized characters is made thinner so as to be able to create a label having increased visibility.

Moreover, as another variation, in the emphasis process in the case where the character color of the character string for a label is monotone, the character color specified as the emphasis range is changed to a darker tone, and when the character color has reached the limit value for the dark tone, the tone of the characters specified as the emphasis range is no longer changed, but rather the character color of non-emphasized characters is changed to a lighter tone, or the hue of the character color of the non-emphasized characters is changed to a lighter color, so that a label with increased visibility can also be created.

Furthermore, in the embodiment described above, the case was explained for the case wherein when it is determined in the character size determination that the character size of an emphasized character string is the maximum printing character size, the character size changer executes the character size changing process that reduces the printing character size of character strings other than the character strings specified by the range specifier by one step, however, it is not absolutely necessary for the emphasized character string to reach the maximum printing character size, and for example, an expansion limit for the size of emphasized character strings can be set beforehand based on a size difference between emphasized characters strings and character strings other than the emphasized character strings that does not give a feeling of unbalance between the character strings, and when an emphasized character string undergoes the emphasis process and the size of the emphasized character string is specified to exceed the expansion limit for the size, control may be performed so that processing is performed to reduce the printing character size of character strings other than the character strings specified by the range specifier.

As described above, with the embodiment of the present invention, it is possible to provide a printer that through the emphasis process creates labels with increased visibility, a printing method for the printer to create labels having increased visibility through the emphasis process, and a storage medium that stores a printing control program for causing the printer to perform the printing method to create labels having increased visibility through the emphasis process.

With the embodiment of the present invention, the emphasis starter makes it possible to prompt the user to determine whether or not to further perform the emphasis process, and thus it is possible to create labels using the emphasis process that corresponds to the desires of the user.

Furthermore, with the embodiment of the present invention, by performing the bolding process that bolds specified character strings, it is possible to create labels using the individualistic emphasis process.

Moreover, with the embodiment of the present invention, by performing character formatting of specified character strings, it is possible to create labels by different variations of the emphasis process.

Furthermore, the processing illustrated in the flowchart of the embodiment of the present invention can be applied as a printing control program that can be executed by a computer to various devices in which the program is written in a memory medium such as a magnetic disk, an optical disk, and a semiconductor memory, or can also be applied to various devices to which the program is transferred by a communication medium. By storing each of the processes of the embodiment described above in a desired memory medium and executing the printing control program by a different computer, the same effect can be obtained as in the case of using the printer of this embodiment. The computer is not limited to a computer inside the printer of this embodiment, and can include any computer that can read the printing control program that is stored in the memory medium and is provided with a calculating device such as a CPU that performs control operation according to the read printing control program.

Having described and illustrated the principles of this application by reference to a preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A printer that prints on a printing medium, comprising:
a printable width setter that sets a printable width that corresponds to a width of the printing medium;
a display that displays a character string;
a specifier that specifies at least one first character selected from the character string displayed on the display, the character string comprises the specified at least one first character and at least one second character;
a requester that requests an emphasis process to the specified at least one first character; and
an emphasis processor that performs a size up process of increasing a size of the specified at least one first character according to the request of the emphasis process requested by the requester until the size of the specified at least one first character reaches the specified size allowed based on the printable width set by the printable width setter,
wherein the emphasis processor maintains the size of the specified at least one first character and performs a size down process of decreasing a size of the at least one second character that has not been specified by the specifier , if the size of the specified at least one first character exceeds the specified size.

2. The printer according to claim 1, wherein
the printer comprises a character inputter that inputs information designating the character string comprising a plurality of characters to be printed on the printing medium; and
the display displays the character string according to the information designating the character string which was inputted by the character inputter.

3. The printer according to claim 1, wherein
the emphasis process includes a process of increasing in steps the character size of the specified at least one first character.

4. The printer according to claim 1, wherein
the emphasis process includes a process of converting a font of the specified at least one first character to a bold font.

5. The printer according to claim 1, wherein
the emphasis process includes a process of performing character formatting of the specified at least one first character.

6. The printer according to claim 1, wherein
the emphasis processor performs the emphasis process that includes the size up process that increases again the size of the specified at least one first character that have already performed the emphasis process.

7. The printer according to claim 1, wherein
the emphasis processor discerns that the at least one second character that has not been specified by the specifier and is converted by the size down process have reached a preset minimum size limit, and stops the emphasis process.

8. The printer according to claim 1, wherein
the printer comprises a printable width identifier that identifies the printable width of the printing medium; and
the printable width setter sets the printable area based on the printable width of the printing medium that was identified by the printable width identifier.

9. The printer according to claim 8, wherein
the printing medium is of cartridge type and configured to be refillable in the printer; and
the printable width identifier identifies a width of the printing medium by discerning the type of a printing medium cartridge that is mounted.

10. The printer according to claim 1, wherein
the printing medium is a tape type medium for printing labels.

11. The printer according to claim 1, wherein
the printer comprises a thermal printing head that selectively generates heat in a plurality heating elements according to printing information to be printed, and is a thermal transfer printer that prints by selectively transferring and affixing a colorant onto the printing medium according to the generated heat of the thermal printing head.

12. A printing method for printing on a printing medium, comprising steps of:
setting a printable width that corresponds to a width of the printing medium;
inputting character string information comprising a plurality of characters to be printed on the printing medium;
displaying an inputted character string;
specifying at least one first character selected from the character string displayed on the display, the character string comprises the specified at least one first character and at least one second character;
requesting an emphasis process to the specified at least one first character;
performing a size up process of increasing a size of the specified at least one first character according to the request of the emphasis process until the size of the specified at least one first character reaches the specified size allowed based on the printable width set by the printable width setting step; and
maintaining the size of the specified at least one first character and performing a size down process of decreasing a size of the at least one second character that has not been specified by the specifying step, if the size of the specified at least one first character exceeds the specified size.

13. The printer according to claim 12, wherein
the emphasis process includes a process that increases in steps the size of the specified at least one first character according to the request.

14. The printer according to claim 12, wherein
the emphasis process includes a process of converting a font of the specified at least one first character to a bold font.

15. The printer according to claim 12, wherein
the emphasis process includes a process of performing character formatting of the specified at least one first character.

16. The printer according to claim 12, wherein
the emphasis process includes the size up process that increases again a size of the specified at least one first character that have already performed the emphasis process.

17. The printer according to claim 12, wherein
the emphasis process includes a process that discerns that the at least one second character that has not been specified and is converted by the size down process have reached a preset minimum size limit and stops the emphasis process.

18. The printer according to claim 12, wherein
the printing medium is of cartridge type and configured to be refillable in the printer; and
a printable width identifier identifies a width of the printing medium by discerning the type of a printing medium cartridge that is mounted.

19. A non-transitory storage medium that stores a control program that causes a computer to perform a process to perform printing on a printing medium, the control program causing the computer to perform processes of:
setting a printable width that corresponds to a width of the printing medium;
inputting character string information comprising a plurality of characters to be printed on the printing medium;
displaying an inputted character string;
specifying at least one first character selected from the character string displayed on the display, the character string comprises the specified at least one first character and at least one second character;
requesting an emphasis process to the specified at least one first character;
performing a size up process of increasing a size of the specified at least one first character according to the request of the emphasis process until the size of the specified at least one first character reaches the specified size allowed based on the printable width set by the printable width setting process; and
maintaining the size of the specified at least one first character and performing a size down process of decreasing a size of the at least one second character that has not been specified by the specifying process, if the size of the specified at least one first character exceeds the specified size.
